(19) United States
(12) Patent Application Publication
(10) Pub. No.: US 2002/0143695 A1
(43) Pub. Date: Oct. 3, 2002

(54) Network auction system

(75) Inventors: Hiroyuki Kobayashi, Saitama-ken (JP); Ko Shirahata, Saitama-ken (JP)

Correspondence Address: GREENBLUM & BERNSTEIN, P.L.C., 1941 ROLAND CLARKE PLACE, RESTON, VA, 20191, US

(73) Assignee: Asahi Kogaku Kogyo Kabushiki Kaisha, Tokyo (JP)

(21) Appl. No.: 10/106,343

(22) Filed: Mar. 27, 2002

(30) Foreign Application Priority Data
Mar. 29, 2001 (JP) 2001-95396

(51) Int. Cl. G06F 17/60

(52) U.S. Cl. 705/37

(57) ABSTRACT

A network auction system is provided with a selling server, a plurality of customer terminals. Each of the plurality of customer terminals is connectable to the selling server through a communication network. Further, the auction system includes a web page creating system that creates a web page which is accessible from each of the plurality of customer terminals through the communication network, a product data base containing product data related to imaging apparatuses subjected to be auctioned, and an image data base containing image data related to imaging apparatuses subjected to be auctioned. The web page creating system is configured to create a web page corresponding to an imaging apparatus designated by a customer terminal. The web page creating system uses data stored in at least the product data base and the image data base when it creates the web page corresponding to the designated imaging apparatus.

### BACKGROUND OF THE INVENTION

The present invention relates to a network auction system for imaging apparatuses, which includes a seller server and client terminals respectively connectable to the seller server through a communication network such as the Internet.

Conventionally, Internet sites for auctioning things are known. The Internet auction system is advantageous since it can invite bidders regardless of place and time.

However, in the Internet auction, information regarding the objects to be auctioned are very limited, and typically, only catalog information such as appearance, specification of the objects, and the like are available. If a plurality of the same type of objects are to be auctioned, it is very difficult for a bidder to select one of them based on the catalog information. In particular, if the objects are imaging apparatuses, even though the on-catalog specifications thereof are similar, images captured by the apparatuses may sometimes have great differences due to individual differences.

For example, if there are a new apparatus and an old type apparatus whose optical specifications are substantially the same, the bidder cannot determine which type apparatus should be bought since he/she cannot know whether the old type apparatus provides images having sufficient quality based on the information published on an auction web site. In such a case, the bidder may lose the chance of bid. Further, even if there are apparatuses of the same type, the quality of the captured images may be different due to individual differences. Furthermore, if there are pre-owned apparatuses of the same type, degree of degradation of the performance thereof may be different due to their pre-used conditions. In a particular case, a pre-owned apparatus may be badly damaged.

Thus, in the conventional Internet auction, it is difficult for bidders (i.e., consumers) to determine a product to buy based only on the information published on the web site. In particular, the apparatuses are imaging apparatuses, the auction system may not function smoothly due to above-described problems.

In view of the above-described problems, it has been desired an improved network auction system which supports customers to select an imaging apparatus, and expedites the sales of the imaging apparatuses in the network auction system.

In this regard, according to one embodiment, there is provided a network auction system, which is provided with a selling server, a plurality of customer terminals, each of the plurality of customer terminals being connectable to the selling server through a communication network, a web page creating system that creates a web page which is accessible from each of the plurality of customer terminals through the communication network, a product data base containing product data related to imaging apparatuses subjected to be auctioned, and an image data base containing image data related to imaging apparatuses subjected to be auctioned. The web page creating system is configured to create a web page corresponding to an imaging apparatus designated by a customer terminal, the web page creating system using data stored in at least the product data base and the image data base.

Optionally, the image data may include images respectively captured by the plurality of imaging apparatuses.

Further, the plurality of imaging apparatuses may include a used imaging apparatus.

Furthermore, the plurality of imaging apparatuses may include an endoscope.

According to another embodiment, there is provided an auction system for imaging apparatuses, which is provided with a selling server, a plurality of customer terminals, each of the plurality of customer terminals being connectable to the selling server through a communication network, a web page creating system that creates a web page which is accessible from each of the plurality of customer terminals through the communication network, a product specification data base containing product specification data related to imaging apparatuses subjected to be auctioned, a repair history data base storing repair history of each of the plurality of imaging apparatuses in relation thereto, and an image data base containing image data related to imaging apparatuses subjected to be auctioned. The web page creating system may be configured to create a web page corresponding to an imaging apparatus designated by a customer terminal, the web page creating system using at least data stored in the product specification data base and the repair history data base.

Optionally, the auction system may include a service terminal accumulating maintenance information, the service terminal being connected to the selling server, repair history data of each of the plurality of imaging apparatuses being retrieved from the maintenance information.

Further, the plurality of imaging apparatuses may include a used imaging apparatus.

According to another embodiment, there is provided an auction system for imaging apparatuses, which is provided with a selling server, a plurality of customer terminals, each of the plurality of customer terminals being connectable to the selling server through a communication network, a web page creating system that creates a web page which is accessible from each of the plurality of customer terminals through the communication network, a product data base containing product data related to imaging apparatuses subjected to be auctioned, an image data base containing image data related to imaging apparatuses subjected to be auctioned, and a repair history data base storing repair history of each of the plurality of imaging apparatuses in relation thereto. The web page creating system may be configured to create a web page corresponding to an imaging apparatus designated by a customer terminal, the web page creating system using at least data stored in the product data base and the repair history data base.

Optionally, the image data may include images respectively captured by the plurality of imaging apparatuses.

Further optionally, the auction system may include a service terminal accumulating maintenance information, the service terminal being connected to the selling server, repair history data of each of the plurality of imaging apparatuses being retrieved from the maintenance information.

Still optionally, the plurality of imaging apparatuses may include a used imaging apparatus.

Optionally, the plurality of imaging apparatuses may include an endoscope.

According to another aspect, there is provided a network auction system for auctioning imaging apparatuses, which includes a selling server, a plurality of customer terminals, each of the plurality of customer terminals being connectable to the selling server through a communication network, a web page creating system that creates a web page which is accessible from each of the plurality of customer terminals through the communication network, and a product data base containing product data related to imaging apparatuses subjected to be auctioned, the product data including image data related to image capturing performance of each of the imaging apparatuses. The system is configured such that the web page creating system creates a web page corresponding to an imaging apparatus designated by a customer terminal, the web page creating system using data stored in the product data base and displaying the image data.

Optionally, the image data related to image capturing performance includes image data captured by each of the imaging apparatuses.

### BRIEF DESCRIPTION OF THE ACCOMPANYING DRAWINGS

FIG. 1 schematically shows a configuration of an auction system for selling electronic endoscope according to a first embodiment of the invention;

FIG. 2 is a block diagram showing a configuration of the sales server according to the first embodiment;

FIG. 3 shows a flowchart illustrating a main flow of a selling procedure employed in the first embodiment;

FIG. 4 shows an example of a screen image of a display device, indicating an apparatus information input form according to the first embodiment;

FIG. 5 shows an example of a screen image indicating a list of the apparatuses, according to the first embodiment;

FIG. 6 shows an example of a screen image indicating a list of apparatus information;

FIG. 7 shows an example of a screen image on which an apparatus is displayed;

FIG. 8 shows an example of a screen image showing bid price information;

FIG. 9 shows an example of a screen image showing a bid price input form;

FIG. 10 shows an example of a screen image showing a bidder registration form;

FIG. 11 shows an example of a screen image indicating the end of bid;

FIG. 12 is a block diagram showing a configuration of a selling server of an auction system of endoscopes according to a second embodiment;

FIG. 13 shows a flowchart illustrating a main flow of a selling procedure employed in the second embodiment;

FIG. 14 shows an example of a screen image of a product information input form;

FIG. 15 shows an example of a screen image of a specification information input form;

FIG. 16 schematically shows an entire structure of an auction system of endoscopes according to a third embodiment;

FIG. 17 is a block diagram showing a configuration of a selling server and a service terminal of the auction system according to the third embodiment;

FIG. 18 a flowchart illustrating a main flow of a selling procedure employed in the third embodiment; and

FIG. 19 shows an example of a screen image of a specification input form.

### DESCRIPTION OF THE EMBODIMENTS

Hereinafter, embodiments of the invention will be described with reference to the accompanying drawings. It should be noted that, in the embodiments described below, the auction systems are f or selling electronic endoscopes. However, the invention is not limited to such systems, and various imaging devices can be subjected to be auctioned.

### FIRST EMBODIMENT

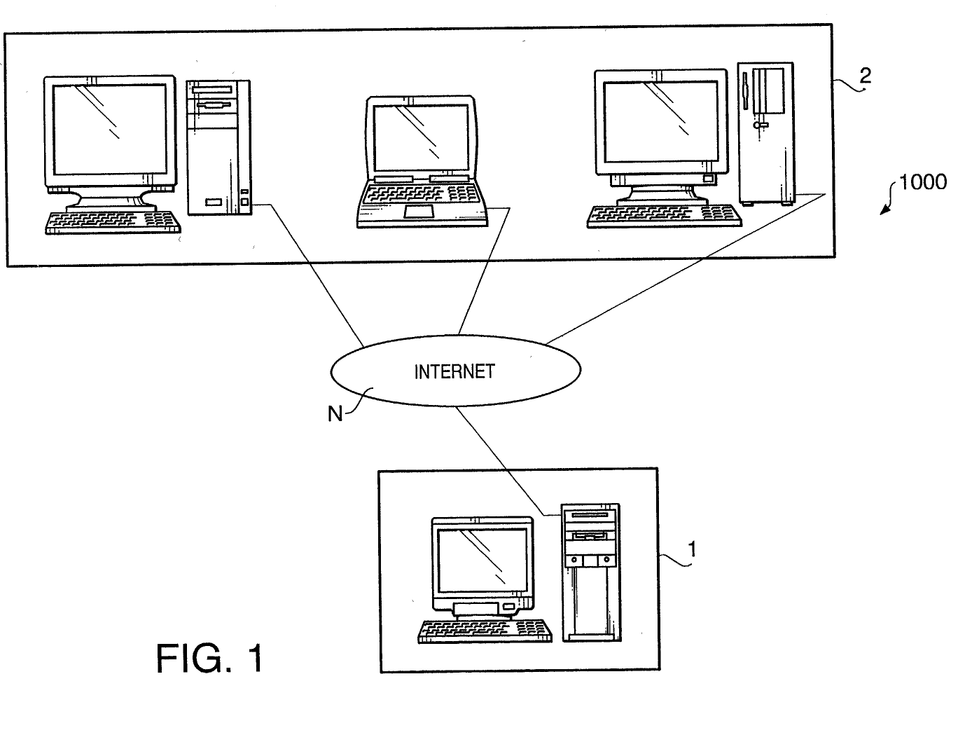

FIG. 1 schematically shows a configuration of an auction system 1000 for auctioning electronic endoscopes, according to a first embodiment of the Invention.

The auction system 1000 includes a selling server 1 and a plurality of bidder terminals 2 interconnected through a network N. The network N is a communication network such as the Internet, intranet or the like. The selling server 1 publishes product information of endoscopes subject to be auctioned through a web page, and through the network N.

A bidder can access the selling server 1 through the network N, browse the web page to view the product (i.e., objects to be auctioned) information, and send a bid offer to the selling server 1. In the published information, the minimum bid price is included, while, in the bid offer, a desired product and a bid price the bidder offers are included.

The selling server 1 checks the bid price included in the bid offer when the selling server 1 receives the same. If the bid price is the highest price ever received for the product, an updating procedure, which will be described later, is executed.

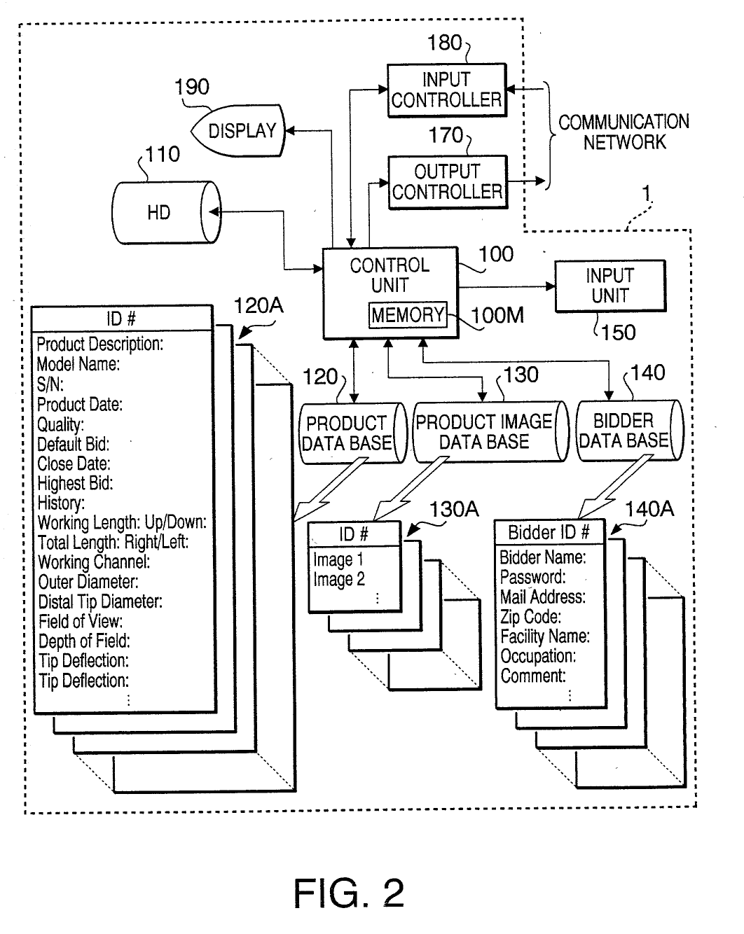

FIG. 2 is a block diagram showing a configuration of the sales server 1.

The selling server 1 has a control unit 100 which controls the entire operation of the selling server 1. The control unit 100 includes:

a hard disk 110 containing a main program for executing the auction;

a product data base 120 containing product information including repair history and ID numbers assigned by the selling server 1 in relation to the corresponding number of pieces of the product information;

an image data base 130 containing images of each product and sample images captured by each product, and the ID numbers related to the products; and

a bidder data base 140 containing bid offer information and, in relation to the same, bidder ID numbers assigned to the registered bidders.

The control unit 100 further includes input devices such as a keyboard and a mouse, an input controller 180 and an output controller 170 that control the input and output operations through the network N, respectively. The control unit 100 further includes a memory 100M which temporarily stores various data.

The product data base 120 has a data structure 120A. That is, the product data base 120 (120A) has, for each product, a product ID number, product description, a model name, a serial number, a product date, repair history, quality, an initial bid price (default bid), a close date (i.e., an end date of the auction), the highest bid and the like. The data base 120 further includes, as the specification data, an effective length (working length), an total length, an inner diameter of each channel, an outer diameter of the endoscope, a diameter of the distal end of the tube, field of view, a depth of field, and tip deflection angles.

The product image data base 130 has a data structure 130A. Specifically, the product image data base 130 (130A) includes, product ID numbers and images of the products. As the image data, images of appearance, enlarged views of a portion (e.g., a tip portion), and images captured by the products (e.g., screen images on a display).

The bidder data base 140 has a data structure 140A. Specifically, the bidder data base 140 (140A) includes bidder ID numbers, names of the bidders, passwords, mail addresses, zip codes of facilities, facility addresses, and bidder jobs. It should be noted that only the bidders registered with the bidder data base 140 can attend the auction performed by the auction system 1000.

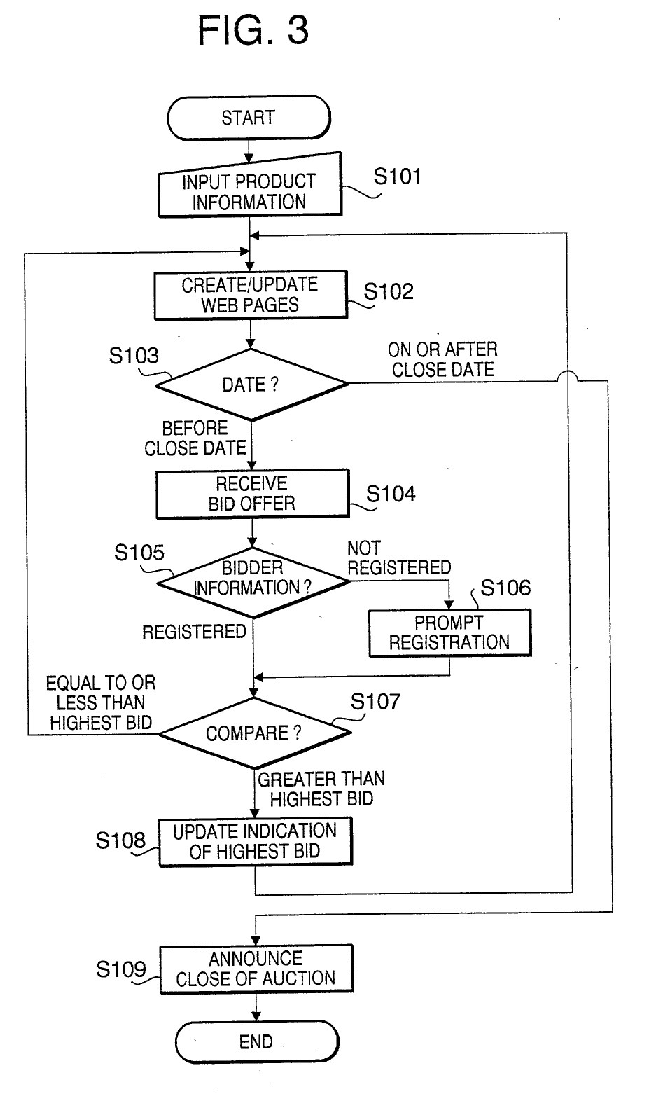

FIG. 3 shows a flowchart illustrating a main flow of a selling procedure employed in the auction system 1000.

In S101, information related to a product to be sold (auctioned) is registered. Registration with the product data base is done by an operator by means of input unit 150 (see FIG. 2).

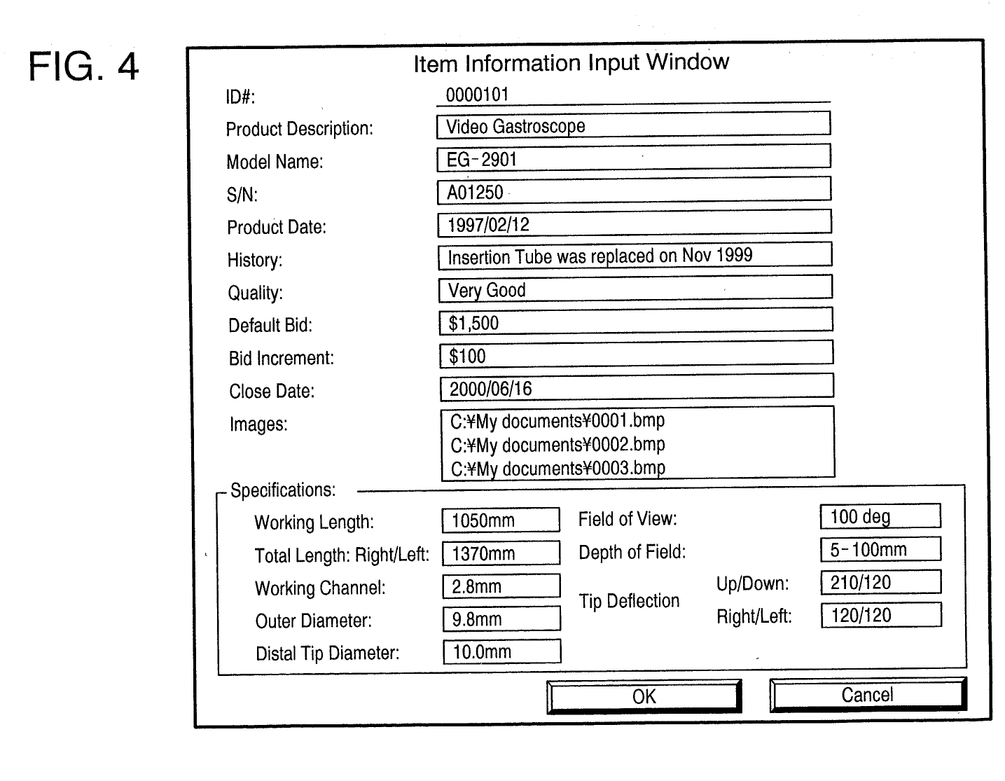

FIG. 4 shows an example of a screen image of a product information input form. The product information form shown in FIG. 4 is displayed on the display device 190 (see FIG. 2). In this example, information to be input includes a product ID number, a product description, a serial number, a product date, repair history, quality, an initial bid (i.e., default bid price), an incremental amount, close date of auction (i.e., end date of the bid offer reception). Further, as specification information intrinsic to the product, a model name, a working length, a total length, a channel diameter, an outer diameter, a distal tip diameter, field of view (angle), depth of field, and tip deflection angles are to be input. If images are available, file names thereof are also input. In the example shown in FIG. 4, the product ID is assigned automatically in the order of the registration. Update of the information is also performed in S101, and the similar input form is displayed.

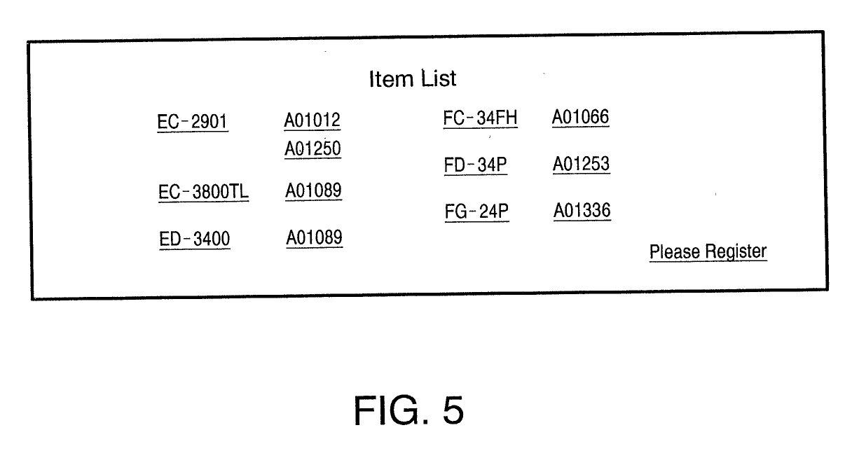

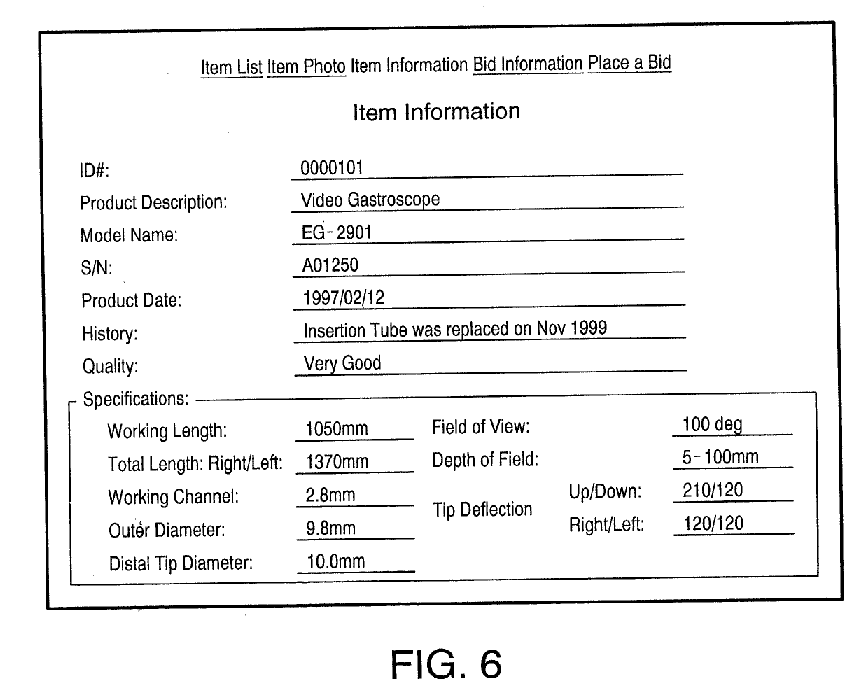

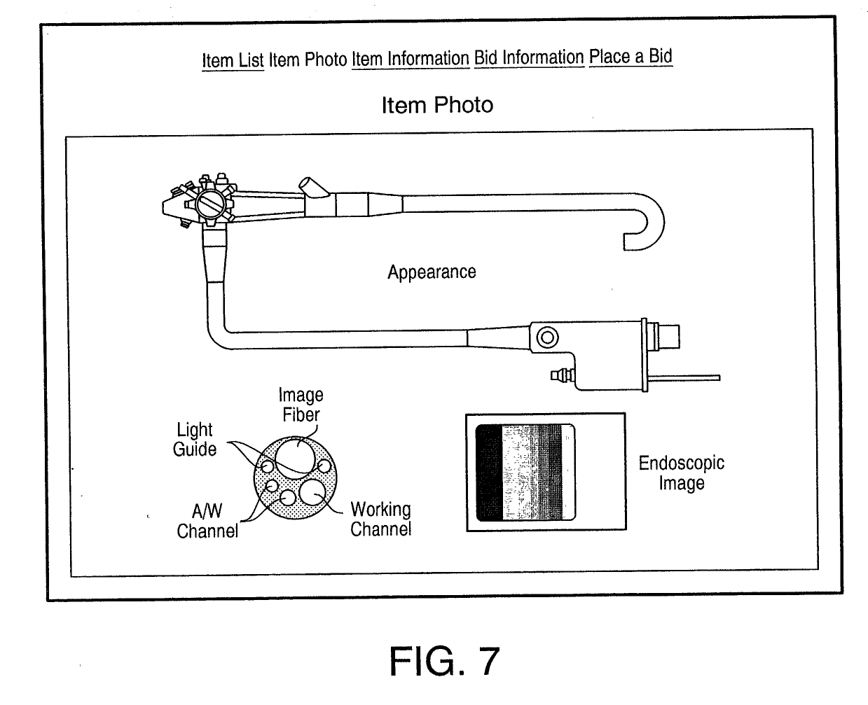

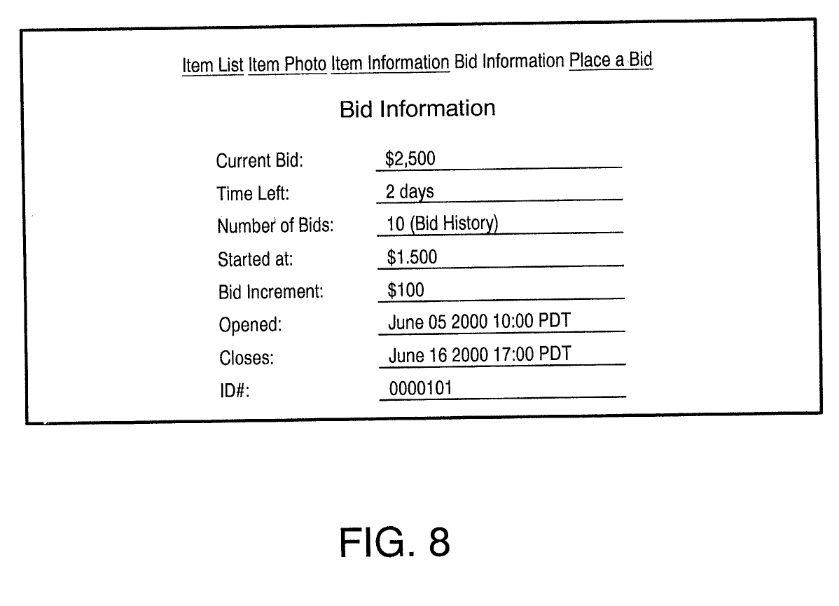

In S102, based on the information input or updated in S101, a product list (see FIG. 5), product information (see FIG. 6), product image (see FIG. 7) and auction information (see FIG. 8) are automatically created. Specifically, the data input in S101 is registered with the product data base 120 as text data. The control unit 100 generate the screen images as web pages as shown in FIGS. 5-8 using mark-up language such as HTML based on the data registered with the product data base 120.

FIG. 5 shows an example of a screen image indicating a product (item) list. Each of the serial numbers of the products is related to a link. By clicking a serial number, a linked page, which shows product information corresponding to the clicked serial number, is displayed. Optionally, access may be restricted if the serial number is clicked by a bidder who is not registered. Alternatively, the access may be restricted such that none of the product information is displayed, that predetermined ones of the product information are not displayed, or that, even though the product information is displayed, the bid offer of the unauthorized bidder is not accepted.

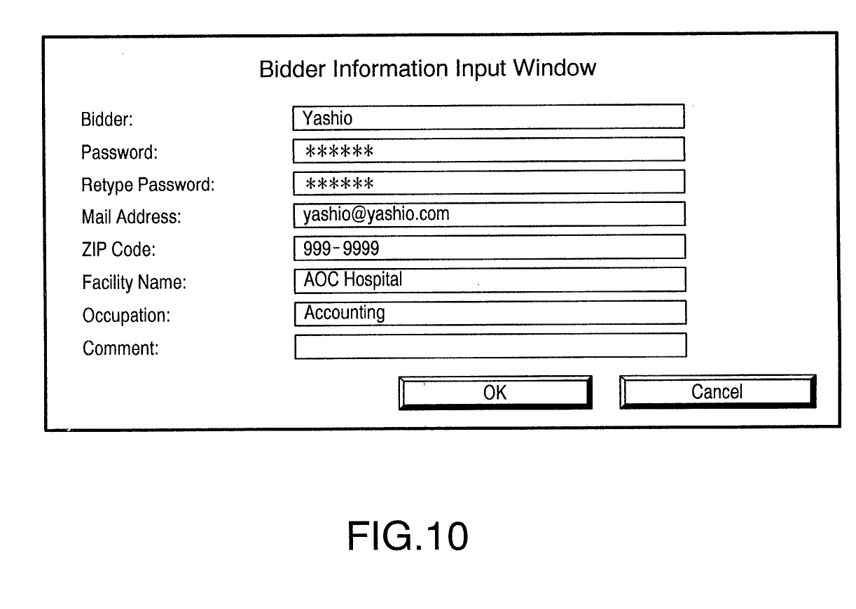

In the auction system 1000, when a bidder intends to attend the auction and accesses the selling server, the product list shown in FIG. 5 is displayed firstly. As shown in FIG. 5, the displayed image also includes a link to a new bidder registration form. If the link is clicked, the registration form as shown in FIG. 10 is displayed.

FIG. 6 shows an example of a screen image indicating product information. As aforementioned, the product information is created based on the information registered with the product data base.

FIG. 7 shows an example of a screen image showing appearance of the product and images captured by the product. This screen image is also created based on the information input in S101 and registered with the product data base 120. The example shown in FIG. 7 illustrates, the appearance of the endoscope, an enlarged image of the tip of the endoscope, and a captured image (i.e., an endoscopic image captured by the product).

It should be noted that periodical maintenance should be done for years, and that individual differences image capturing performance of the endoscopes are significant. Specifically, the electronic endoscopes employs a number of light fiber bundles, which may broken or deteriorated across the ages and/or depending on used conditions. The individual differences are more significant than those of digital cameras or the like.

According to the configuration described above, since the images captured by the product being auctioned are published on the web site as well as the repair history, the bidders can understand the current condition of the product accurately.

FIG. 8 shows an example of a screen image showing bid price information. On the bid price information screen, the end date of the auction, and a remaining time are displayed. If the bid price place by the bidder exceeds the highest bid currently registered with the data base 120, the product data base 120 is updated, and accordingly, the current bid price information on the auction information display screen is updated. When the bid price information is updated, the number of the bids is also updated.

In S103, the end date input in S101 and the current date are compared, and if the current date exceeds the end date of the auction, control goes to S109. If the current date does not exceed the end date, control goes to S104. In a procedure from S104 to S106, bid offers by bidders can be received.

In S104, the bidder is capable of inputting a bid price. When the bidder inputs the bid price, by clicking the product list, he/she can refer to the product information (see FIG. 6), product image information (see FIG. 7) and auction information (see FIG. 8) and determine the product to buy and the bid price to place.

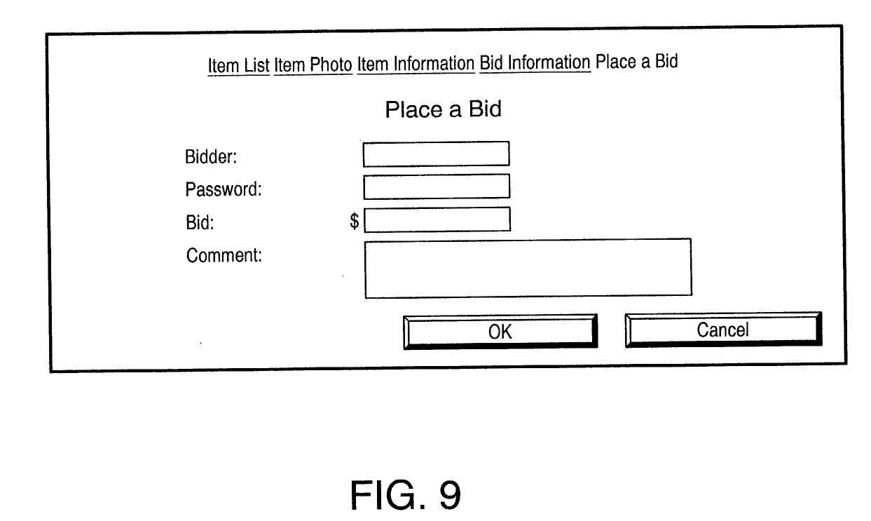

FIG. 9 shows an example of a screen image showing the bid price input form. The bidder is required to input the name, password, bid price and comments.

The selling server 1 checks whether the bidder is a registered one or not based on the input name and password. If the bidder has been registered, the bid price is accepted and is compared with the highest price stored in the data base. If the bidder is not registered, a registration form is displayed on the display device 9.

It is preferable that, in each of the product information screen (FIG. 6), the product image display screen (FIG. 7), the auction information screen (FIG. 8), the bid price input form (FIG. 9), links to go the other screens are provided.

In S105, it is judged whether the bidder who has placed the intended bid price has been registered with the bidder information data base by searching the bidder ID. If the bidder has been registered, control goes to S107. If the bidder has not registered with the data base, control goes to S106, where the registration form as shown in FIG. 10 is displayed, and the bidder is required to fill in the form.

In S107, the intended bid price and the current highest bid price are retrieved and stored in the memory 100M. Then, the bid prices stored in the memory 100M are compared. If the intended bid price exceeds the highest bid price, control goes to S108. If the intended bid price is equal to or lower than the highest bid price, control goes to S102 to wait until another bid is offered.

In S108, the highest bid price in the product data base is updated, and control goes to S102.

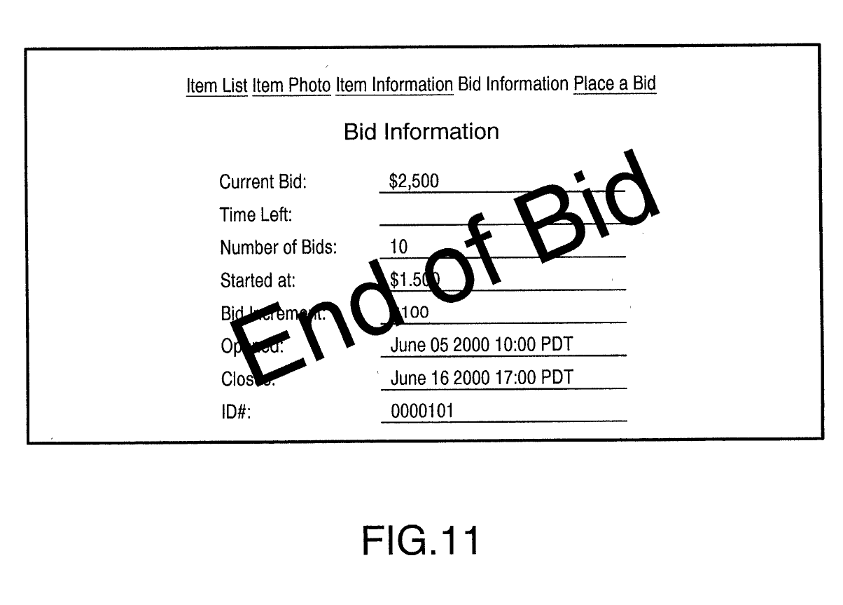

In S109, the end procedure is executed. Specifically, in S109, an image indicating that the reception of the bid prices are terminated (see FIG. 11). Then, to the winning bidder, an e-mail message notifying the result is sent. Further, in the product list, the product sold in the above procedure is deleted, and in the product information screen, the product image displaying screen, bid information screen and bid price input screen, a message indicating that the product has been sold is displayed. FIG. 11 shows an example of a screen image bearing such a message.

### SECOND EMBODIMNET

In the first embodiment, information is registered with the product data base 120 for each product. However, the same products have the same specification, and therefore, it is convenient to store the specification data in a separate data base and commonly used for a plurality of products when the web page is created. An example of such a configuration will be described as a second embodiment.

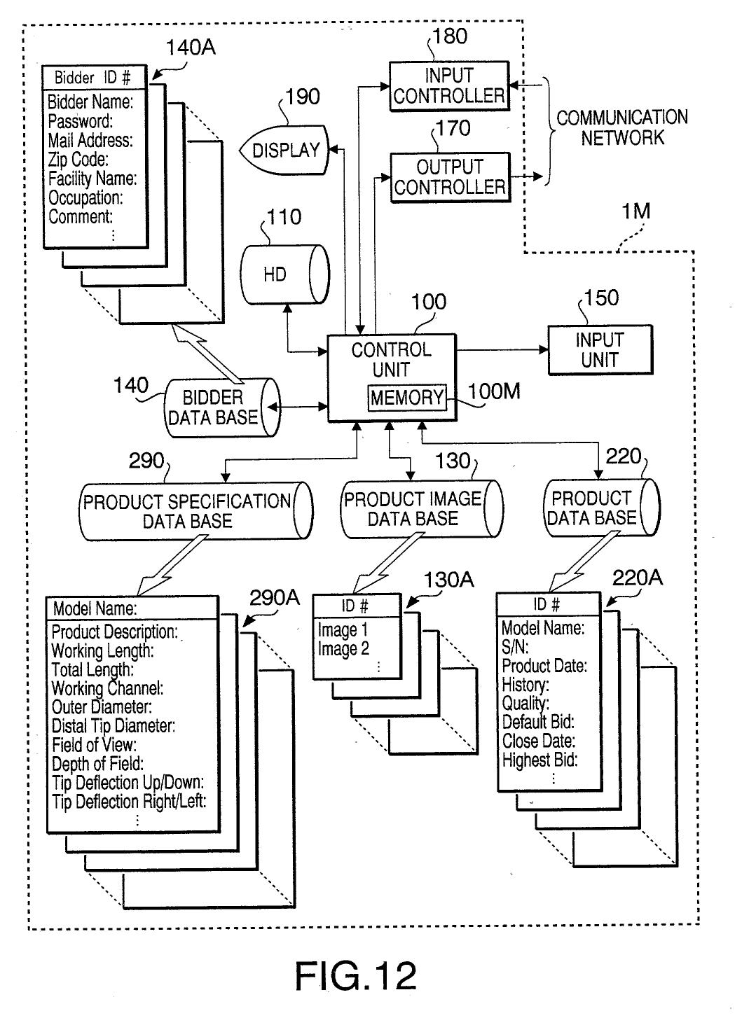

FIG. 12 is a block diagram showing a configuration of a selling server 1M of an auction system of endoscopes according to the second embodiment. The entire configuration of the auction system is substantially similar to that of the first embodiment except that the selling server 1 of the first embodiment is replaced with the selling server 1M. It can be easily understood by comparing FIGS. 2 and 12 that the product data base 120 of the first embodiment is replaced with a product data base 220 and a product specification data base 290. The product data base 220 and the product specification data base 290 have a data structure 290A and data structure 220A, respectively. The product specification data base 290 stores product specification data in relation to product numbers. In the example shown in FIG. 12, the product specification data 290 includes product description, working length, total length, working channel diameter, outer diameter, distal tip diameter, field of view, depth of field, tip deflection angles(up/down and right/left).

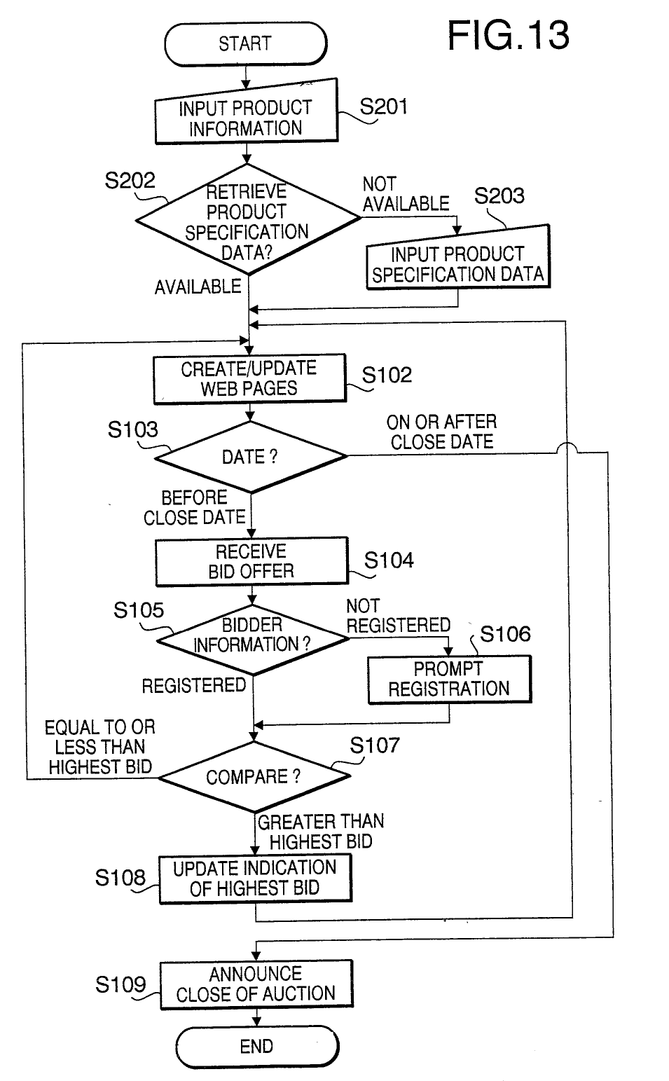

FIG. 13 shows a flowchart illustrating a main flow of a selling procedure employed in the second embodiment. The procedure shown in FIG. 13 is substantially similar to that shown in FIG. 3 except that step S101 is replaced with steps S201 for inputting the product information and steps S202 and S203. The following procedures are the same as in the first embodiment. Accordingly, only steps S201, S202 and S203 will be described.

In S201, information of products to be sold is registered with the product database. Input of the data is done by an operator using the input unit 150.

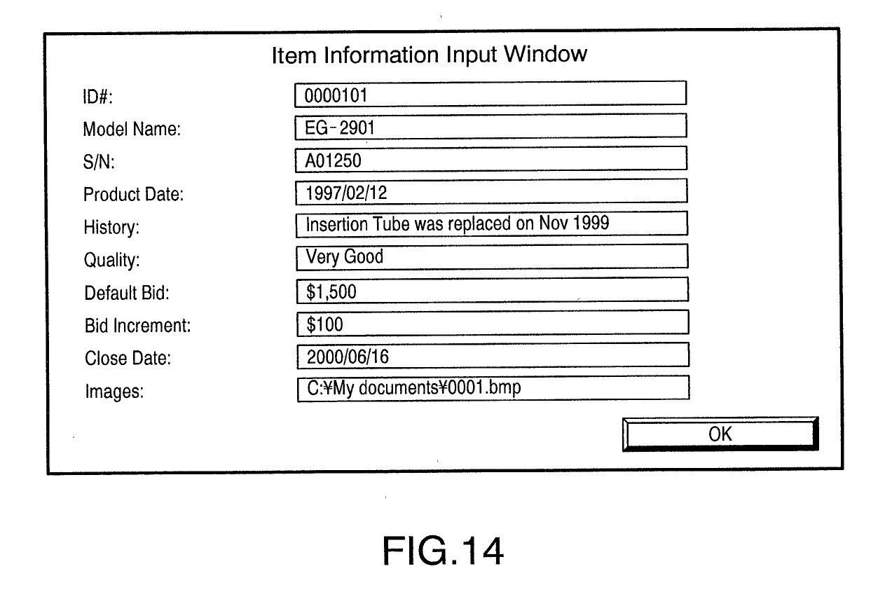

FIG. 14 shows an example of a screen image of a product information input form, which is displayed on the display 190. The flowchart shown in FIG. 14 is similar to that shown in FIG. 4 except that the items relating to the product specification are omitted. It is because, according to the second embodiment, the specification data can be retrieved from the specification data base based on the model name. Therefore, in the example shown in FIG. 14, the input data includes model name, serial number, product date, repair history, quality, initial price (minimum bid price), end date of the auction. Similarly to the first embodiment, the product ID is automatically assigned in the order of registration.

S202, based on the model name input in S201, the specification data corresponding to the model name is retrieved in the product specification data base. If the corresponding specification data is available (S202: YES), control goes to S102. The procedure thereafter is similar to that in the first embodiment. If the specification data corresponding to the input model name is not available in the product specification data base 290 (S202: NO), control goes to S203.

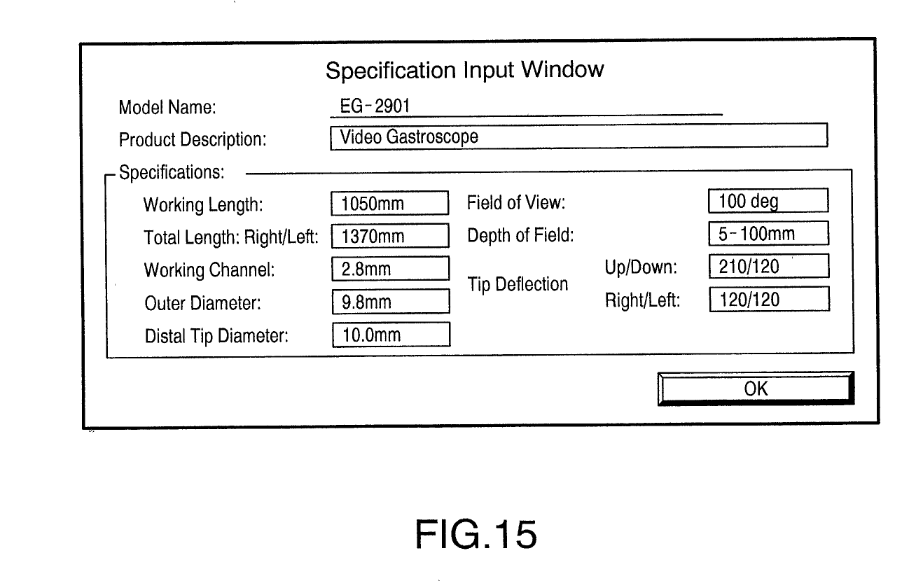

In S203, the specification information input form as shown in FIG. 15 is displayed. This form corresponds to the lower half of the input form shown in FIG. 4. As shown in FIG. 15, the information to be input includes product description, working length, total length, working channel diameter, outer diameter, distal tip diameter, field of view, depth of field and tip deflection angles (up/down and right/left). The information input in this step is registered with the product specification data base 290, and will be referred to if the specification of the same model is required. After the specification data is registered with the product specification data base 290, control goes to S102.

### THIRD EMBODIMENT

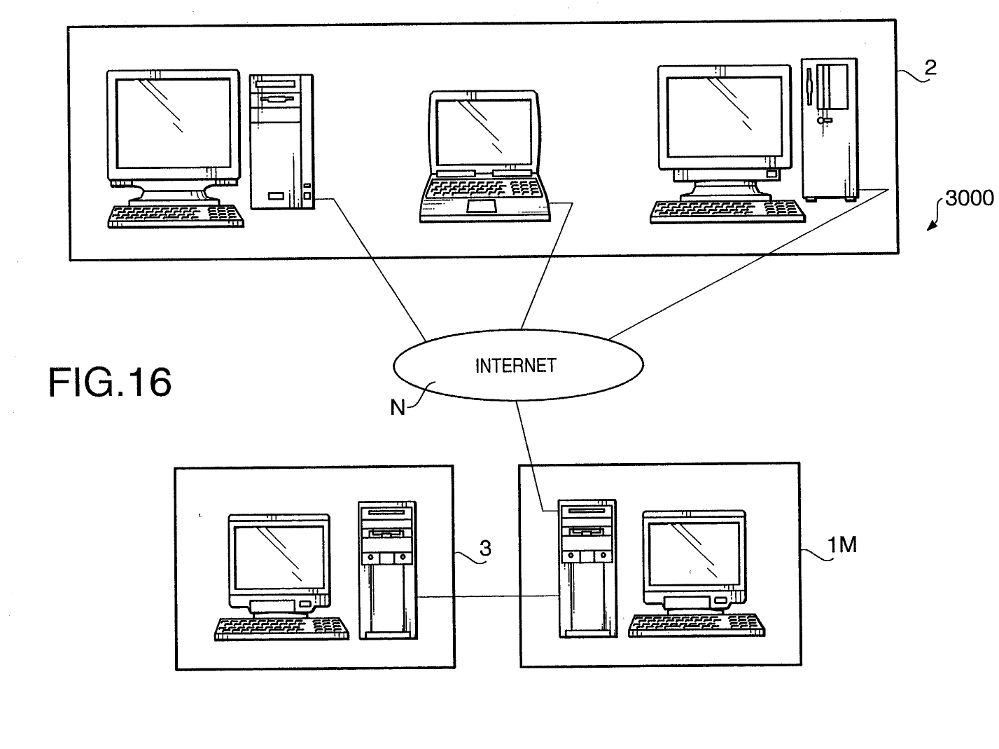

FIG. 16 schematically shows an entire structure of an auction system 3000 of endoscopes according to a third embodiment.

The auction system 3000 includes a selling server 1M and a plurality of bidder terminals 2 connected through a network N. The network N is a communication network such as the Internet or intranet. The auction system 3000 has a service terminal 3 which is connected to the selling server 1M through a dedicated line DL.

According to the third embodiment, the service terminal 3 has a repair data base which contains repair history of endoscopes sold in the past in relation to the model names and serial numbers. The selling server IM retrieves the repair history from the service terminal 3 when a product to be sold through the network N includes the repossessing device from a client, and add the same to the information published.

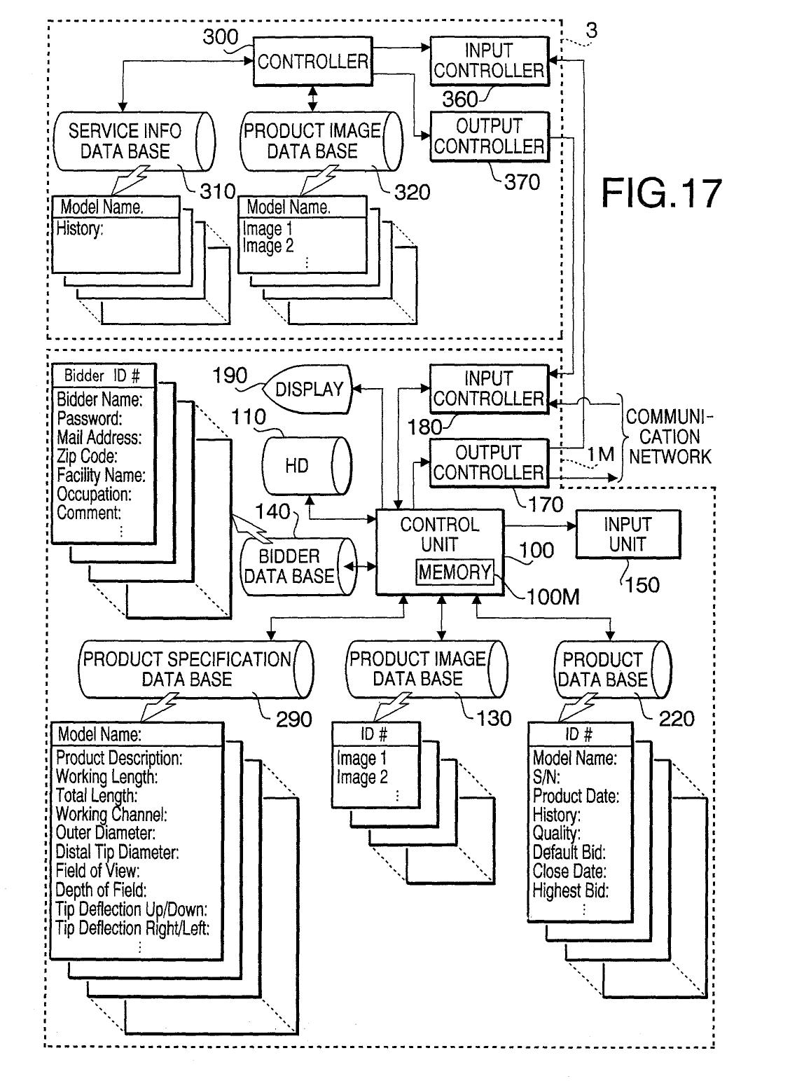

FIG. 17 is a block diagram showing a configuration of the selling server 1M and a service terminal 3 of the auction system 3000. The configuration of the selling server 1M is similar to that of the second embodiment.

The selling server 1M publishes the product information subject to be sold as a web page through the network N. Bidders can access the web page through the network N using the bidder terminals 2, browse the product information as published, and offer bids, if desired products are available, to the selling server 1M.

The service terminal 3 includes a controller 300 which controls the entire operation of the service terminal 3, and the service information data base 310 as described above.

Further, as shown in FIG. 17, the service terminal 3 includes a product image data base 320. The product image data base 320 stores images of appearance and images captured by the products in relation to the model names and serial numbers, similarly to the product image data base of the selling server 1M. According to the third embodiment, using an input system like a digital still camera or a motion image capturing device (not shown), images related to each product can be registered with the product image data base 320 independently from the product image data base of the selling server IM.

It should be noted that, in the service terminal 3, the products are managed with reference to the serial numbers but not product IDs. It is because, the service terminal 3 deals with not only the products to be sold through the network N but also new products and/or repaired products.

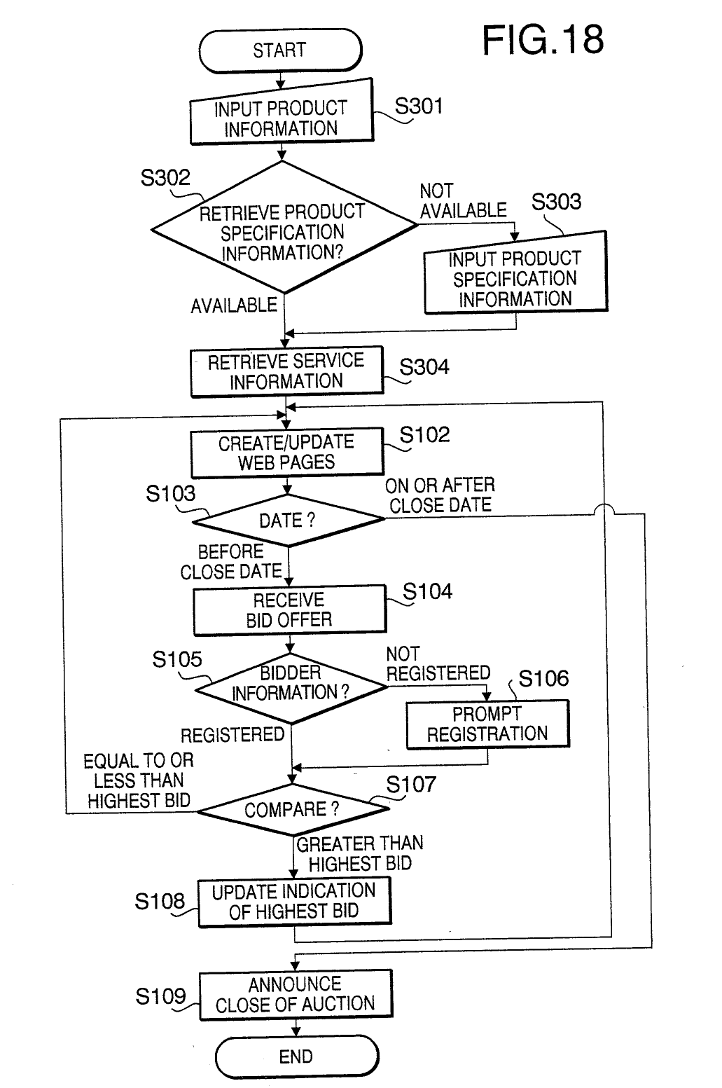

FIG. 18 a flowchart illustrating a main flow of a selling procedure employed in the third embodiment. The procedure shown in FIG. 18 is similar to that shown in FIG. 3 except that step S101 of FIG. 3 is replaced with steps S301-S304. The procedure after step S304 is similar to that shown in FIG. 3.

In S301, the product information of a product to be sold is registered with the product data base. The product information is input by an operator using an input unit 150.

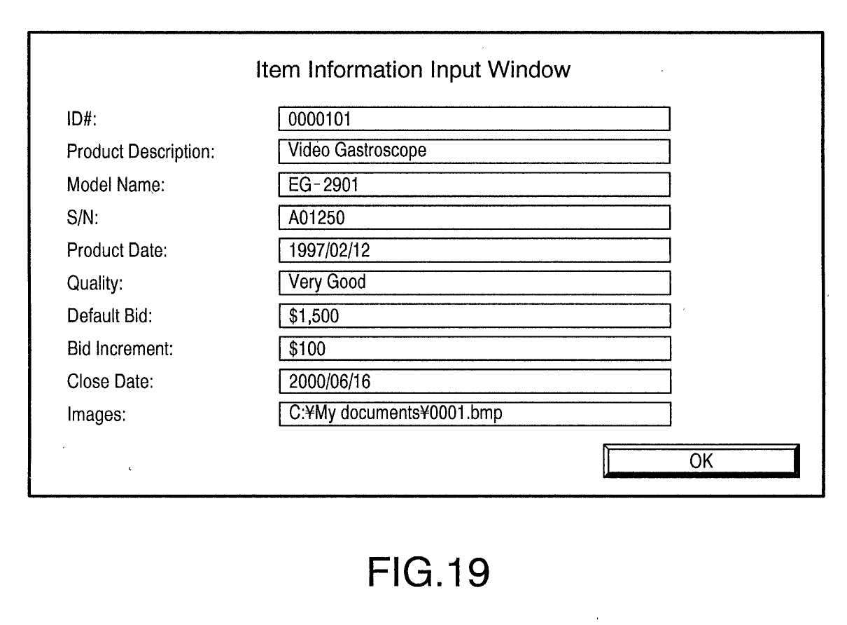

FIG. 19 shows an example of a screen image of a product specification input form. This form is similar to the input form shown in FIG. 14 except the item related to the repair history is omitted. It is because, as described later, the repair history can be obtained from the service terminal 3. Accordingly, the information to be inputted includes product description, model name, serial number, product date, quality, initial bid (default bid price), close date (end date of the auction) and the like. The product ID is automatically assigned in the order of registration.

In S302, based on the model name input in S301, the specification information related to the product is retrieved from the product specification data base. If the specification information of the product is available (S302: YES), control goes to S304. If the specification information of the product is not registered in the product specification data base 290 (S302: NO), control goes to S303.

In S303, the specification information input form as shown in FIG. 15 is displayed. As shown in FIG. 15, the information to be input is common among the same model, which includes product description, working length, total length, working channel diameter, outer diameter, distal tip diameter, field of view, depth of field and tip deflection angles (up/down and right/left). The information input in this step is registered with the product specification data base 290, and will be referred to if the specification of the same model is required. After the specification data is registered with the product specification data base 290, control goes to S304.

In S304, in accordance with the model name and the serial number input in S301, service information corresponding to the product is retrieved in the service data base 320 in the service line 3. If the service information (e.g., the repair history) is available in the service data base 320, the information is retrieved and control goes to S102. The procedure from S102 is similar to that in the first embodiment.

It should be noted that, in the third embodiment, the auction system is described such that the service terminal includes the service data base containing the service information such as the repair history. However, the invention is not limited to such a configuration, and the embodiment can be modified in various ways without departing from the gist of the invention.

For example, the selling server may be configured to have a repair history data base as well as the product data base and the product specification data base. Furthermore, the service terminal is not limited to a single terminal, but include a plurality of service terminals which are connectable with the selling server through the network N.

According to the second and third embodiment, similarly to the first embodiment, since the images captured by the product being auctioned are published on the web site as well as the repair history, the bidders can understand the current condition of the product accurately.

The embodiments are described as auction systems. However, the configurations can apply not only to the auction system, but also to catalog selling system using the Internet or the like.

The present disclosure relates to the subject matter contained in Japanese Patent Application No. 2001-095396, filed on Mar. 29, 2001, which is expressly incorporated herein by reference in its entirety.

What is claimed is:

1. A network auction system for auctioning imaging apparatuses, comprising:
a selling server;
a plurality of customer terminals, each of said plurality of customer terminals being connectable to said selling server through a communication network;
a web page creating system that creates a web page which is accessible from each of said plurality of customer terminals through said communication network;
a product data base containing product data related to imaging apparatuses subjected to be auctioned; and
an image data base containing image data related to imaging apparatuses subjected to be auctioned,
wherein said web page creating system creates a web page corresponding to an imaging apparatus designated by a customer terminal, said web page creating system using data stored in at least said product data base and said image data base.

2. The auction system according to claim 1, wherein said image data includes images respectively captured by said plurality of imaging apparatuses.

3. The auction system according to claim 1, wherein said plurality of imaging apparatuses include a used imaging apparatus.

4. The auction system according to claim 1, wherein said plurality of imaging apparatuses include an endoscope.

5. A network auction system for auctioning imaging apparatuses, comprising:
a selling server;
a plurality of customer terminals, each of said plurality of customer terminals being connectable to said selling server through a communication network;
a web page creating system that creates a web page which is accessible from each of said plurality of customer terminals through said communication network;
a product specification data base containing product specification data related to imaging apparatuses subjected to be auctioned;
a repair history data base storing repair history of each of said plurality of imaging apparatuses in relation thereto; and
an image data base containing image data related to imaging apparatuses subjected to be auctioned,
wherein said web page creating system creates a web page corresponding to an imaging apparatus designated by a customer terminal, said web page creating system using at least data stored in said product specification data base and said repair history data base.

6. The auction system according to claim 5, wherein said auction system includes a service terminal accumulating maintenance information, said service terminal being connected to said selling server, repair history data of each of the plurality of imaging apparatuses being retrieved from the maintenance information.

7. The auction system according to claim 5, wherein said plurality of imaging apparatuses include a used imaging apparatus.

8. The auction system according to claim 5, wherein said plurality of imaging apparatuses include an endoscope.

9. A network auction system for auctioning imaging apparatuses, comprising:
a selling server;
a plurality of customer terminals, each of said plurality of customer terminals being connectable to said selling server through a communication network;
a web page creating system that creates a web page which is accessible from each of said plurality of customer terminals through said communication network;
a product data base containing product data related to imaging apparatuses subjected to be auctioned; and
an image data base containing image data related to imaging apparatuses subjected to be auctioned;
a repair history data base storing repair history of each of said plurality of imaging apparatuses in relation thereto; and
wherein said web page creating system creates a web page corresponding to an imaging apparatus designated by a customer terminal, said web page creating system using at least data stored in said product data base and said repair history data base.

10. The auction system according to claim 9, wherein said image data includes images respectively captured by said plurality of imaging apparatuses.

11. The auction system according to claim 9, wherein said auction system includes a service terminal accumulating maintenance information, said service terminal being connected to said selling server, repair history data of each of the plurality of imaging apparatuses being retrieved from the maintenance information.

12. The auction system according to claim 9, wherein said plurality of imaging apparatuses include a used imaging apparatus.

13. The auction system according to claim 9, wherein said plurality of imaging apparatuses include an endoscope.

14. A network auction system for auctioning imaging apparatuses, comprising:
a selling server;
a plurality of customer terminals, each of said plurality of customer terminals being connectable to said selling server through a communication network;
a web page creating system that creates a web page which is accessible from each of said plurality of customer terminals through said communication network; and
a product data base containing product data related to imaging apparatuses subjected to be auctioned, said product data including image data related to image capturing performance of each of said imaging apparatuses,
wherein said web page creating system creates a web page corresponding to an imaging apparatus designated by a customer terminal, said web page creating system using data stored in said product data base and displaying said image data.

15. The network auction system according to claim 14, wherein said image data related to image capturing performance includes image data captured by each of said imaging apparatuses.
